(19) United States
(12) Patent Application Publication
(10) Pub. No.: US 2012/0275738 A1
(43) Pub. Date: Nov. 1, 2012

(54) LIGHTWEIGHT BEARING

(75) Inventor: Satoshi TANGE, Osaka (JP)

(73) Assignee: TANGE SEIKI TAICHUNG CO., LTD.

(21) Appl. No.: 13/448,625

(22) Filed: Apr. 17, 2012

(30) Foreign Application Priority Data
Apr. 26, 2011 (TW) 100114470

(51) Int. Cl. F16C 19/02; F16C 19/22

(52) U.S. Cl. 384/490; 384/548

(57) ABSTRACT

A lightweight bearing includes an inner race, an outer race and a plurality of rolling members. The outer race is provided with an inner layer and an outer layer that is connected with the inner layer and provided with a density smaller than that of the inner layer. The rolling members are rotatably disposed between the inner race and the inner layer of the outer race. Because the inner race and the inner layer of the outer race are both made from a material having a good wear resistance, they can resist the wear due to the friction caused by the rolling members in rolling contact with them. In addition, a part of the outer race is made from a material having a relatively smaller density, such that the lightweight bearing has a weight smaller than that of a conventional bearing.

### BACKGROUND OF THE INVENTION

1. Field of the Invention

The present invention relates generally to bearings, and more particularly, to a bearing having a light weight.

2. Description of the Related Art

The structure of conventional bearings usually comprises an outer race, an inner race and a plurality of rolling members, such as balls, cylindrical rollers and needles, rotatably disposed between the inner and outer races. Because the rolling members will continuously rub the inner and outer races when the bearing is in use, the inner and outer races are mostly made from stainless steel or bearing steel, which is a material having a good wear resistance, resulting in that the conventional bearings may have a certain weight.

Nowadays, many bearing-equipped products, bicycles for example, are required to be lightweight. However, the weight of the conventional bearings may limit the extent of weight reduction. In other words, the conventional bearings need to be improved.

### SUMMARY OF THE INVENTION

The present invention has been accomplished in view of the above-noted circumstances. It is therefore the primary objective of the present invention to provide a lightweight bearing having a relatively smaller weight compared to the conventional bearings.

To achieve the above-mentioned objective, the lightweight bearing provided by the present invention comprises an inner race, an outer race and a plurality of rolling members. The outer race is provided with an inner layer and an outer layer, which are connected with each other. The outer layer of the outer race has a density smaller than that of the inner layer. The rolling members are rotatably disposed between the inner race and the inner layer of the outer race. Since the inner race and the inner layer of the outer race are both made from a material having a good wear resistance, they can resist the wear due to the friction caused by the rolling members in rolling contact with them. In addition, the outer layer of the outer race is made from a material having a relatively smaller density, so that the lightweight bearing of the present invention has a weight smaller than that of the conventional bearing.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic cross-sectional view of a lightweight bearing according to a first preferred embodiment of the present invention; and

FIG. 2 is a schematic cross-sectional view of a lightweight bearing according to a second preferred embodiment of the present invention.

### DETAILED DESCRIPTION OF THE INVENTION

It is to be mentioned that same or similar parts disclosed in the preferred embodiments and the drawings, which will be detailedly described hereunder, are denoted with same reference numerals for the purpose of concise illustration of the present invention.

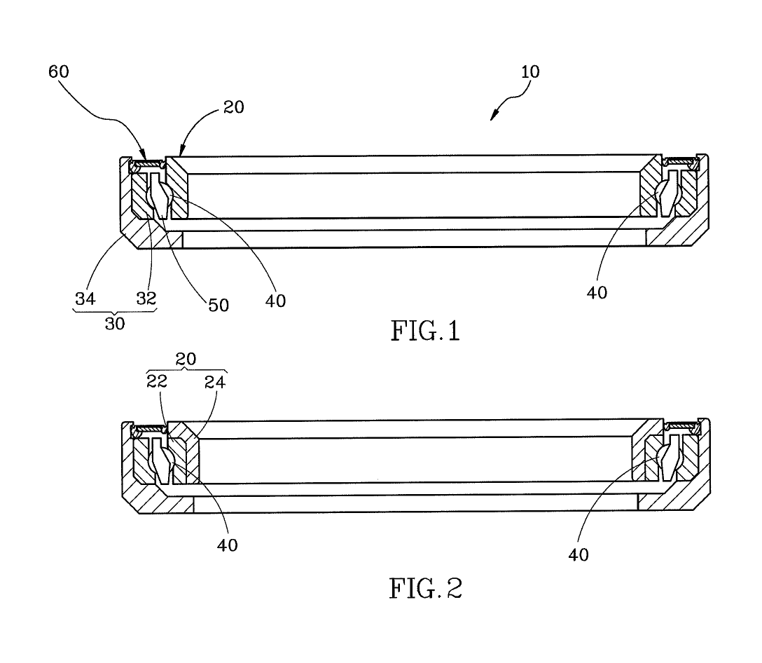

FIG. 1 shows a lightweight bearing 10 according to a first preferred embodiment of the present invention. The lightweight bearing 10 comprises an inner race 20, an outer race 30 and a plurality of rolling members 40.

The configurations of the inner race 20 and the outer race 30 are similar to those of the inner and outer races of the conventional bearings. However, in this embodiment the outer race 30 is formed of an inner layer 32 and an outer layer 34, which are firmly fitted with each other.

The rolling members 40 are balls made from bearing steel or stainless steel and commonly seen in the conventional bearings. However, it'll be appreciated that cylindrical rollers or needles can be used as the rolling member 40 in this preferred embodiment of the present invention. The rolling members 40 are spacedly mounted to a cage 50 disposed between the inner race 20 and the outer race 30. This enables the rolling members 40 to be rotatably disposed between the inner race 20 and the inner layer 32 of the outer race 30. This also reduces wear, friction and the amount of the rolling members 40 used because the cage 50 avoids the rolling members 40 rubbing against each other as they roll, and precludes them from jamming. In addition, a dust-resistant cover 60 is provided between the inner race 20 and the outer race 30 to avoid foreign objects that may interfere with the movements of the rolling members 40 from entering the space between the inner and outer races 20 and 30. However, it'll be appreciated that the lightweight bearing 10 provided by the present invention may be constructed without such cage 50 and dust-resistant cover 60.

The inner race 20 and the inner layer 32 of the outer race 30 are made from a material having a relatively greater density, such as bearing steel or stainless steel, which usually has a relatively greater hardness and a relatively greater wear resistance, so as to avoid wear as they are rubbed by the rolling members 40. The outer layer 34 of the outer race 30 is made from a material having a relatively smaller density, such as aluminum, aluminum alloy, titanium or titanium alloy, which usually has a relatively smaller hardness and a relatively smaller wear resistance. In other words, a great part of the outer race of a conventional bearing is replaced by a material having a relatively smaller density in this invention, and the element contacting the rolling members, i.e. the inner race, remains to be made from a high-density material of relatively greater wear resistance. As a result, the weight of the bearing 10 will be certainly lighter than that of the conventional bearing.

It is to be mentioned that in the above-mentioned embodiment the volume of the outer race 30 of the bearing 10 is shown bigger than that of the inner race 20, so that the outer race 30 is formed with an inner layer 32 that can resist wear and an outer layer 34 for reducing overall weight of the bearing 10. However, as shown in FIG. 2, the inner race 20, which has a certain volume, can also be formed of a first layer 22 contacting the rolling members 40 and a second layer 24 firmly connected with the first layer 22 and having a density and a hardness smaller than the density and the hardness of the first layer 22. This design of the inner race 20 also helps reduction of weight of the bearing 10.

It is to be understood that the bearing 10 may comprise the two-layered inner race 20 having the first layer 22 and the second layer 24 and the outer race 30 of a single piece without the inner layer 32 and the outer layer 34 if the outer race 30 has a small volume. In practice, as long as a part of the inner race 20 or the outer race 30 of the bearing 10 is made form a material having a relatively smaller density, the weight of the bearing 10 will be lighter than that of the conventional one so as to achieve the purpose of weight reduction.

The invention being thus described, it will be obvious that the same may be varied in many ways. For example, the configurations of the inner layer 32 and the outer layer 34 of the outer race 30 may vary according to actual need, and the inner layer 32 and the outer layer 34 may be bonded together by adhesive or suitable anchoring way. Such variations are not to be regarded as a departure from the spirit and scope of the invention, and all such modifications as would be obvious to one skilled in the art are intended to be included within the scope of the following claims.

What is claimed is:

1. A lightweight bearing comprising:
an inner race;
an outer race having an inner layer and an outer layer connected with the inner layer and having a density smaller than that of the inner layer; and
a plurality of rolling members rotatably disposed between the inner race and the inner layer of the outer race.

2. The lightweight bearing as claimed in claim 1, wherein the inner layer of the outer race is made from stainless steel or bearing steel.

3. The lightweight bearing as claimed in claim 1, wherein the outer layer of the outer race is made from aluminum, aluminum alloy, titanium or titanium alloy.

4. The lightweight bearing as claimed in claim 1, wherein the inner race comprises a first layer contacting the rolling members, and a second layer connected with the first layer and having a density smaller than that of the first layer.

5. The lightweight bearing as claimed in claim 4, wherein the first layer of the inner race is made from stainless steel or bearing steel.

6. The lightweight bearing as claimed in claim 4, wherein the second layer of the inner race is made from aluminum, aluminum alloy, titanium or titanium alloy.

7. A lightweight bearing comprising:
an inner race having a first layer and a second layer connected with the first layer and having a density smaller than that of the first layer;
an outer race; and
a plurality of rolling members rotatably disposed between the first layer of the inner race and the outer race.

8. The lightweight bearing as claimed in claim 7, wherein the first layer of the inner race is made from stainless steel or bearing steel.

9. The lightweight bearing as claimed in claim 7, wherein the second layer of the inner race is made from aluminum, aluminum alloy, titanium or titanium alloy.
